(19) United States
(12) Patent Application Publication
(10) Pub. No.: US 2013/0173438 A1
(43) Pub. Date: Jul. 4, 2013

(54) Computer-Implemented Profitability Optimization Process

(71) Applicant: Robert J. Shaw, Far Hills, NJ (US)

(72) Inventor: Robert J. Shaw, Far Hills, NJ (US)

(21) Appl. No.: 13/729,712

(22) Filed: Feb. 4, 2013

Related U.S. Application Data
(60) Provisional application No. 61/582,032, filed on Dec. 30, 2011.

(51) Int. Cl. G06Q 40/00

(52) U.S. Cl. CPC G06Q 40/10
USPC 705/30

(57) ABSTRACT

The present invention relates to a method for rigorous decomposition of a business entity's income statement into a multi-dimensional profitability model and a subsequent dissemination of granular profitability information to all levels of the organization. By decomposing the business's income statement into fully-loaded components and assigning employees to be accountable for each subdivision, the process enables precise profitability optimizing tactics to be originated and implemented at every level of the organization. As a benefit, the business entity typically experiences a dramatic improvements in profitability.

### FIELD OF INVENTION

The present invention relates to a method for analyzing financial results of a business entity that identify opportunities to improve and optimize said business entity's financial viability. In another aspect, the invention also provides a method to monitor ongoing operations of said business entity. In one aspect, the invention relates to rigorously decomposing said business entity's income statement into a multi-dimensional profitability model and a subsequent disseminating its granular profitability information to all levels of the organization.

By decomposing the business entity's income statement into fully-loaded components, for example, by customer, product, territory, and other dimensions; and then, for example, assigning employees to be accountable for each such subdivision, the method of the present invention enables origination and implementation of precise profitability optimization strategies at every level of the organization. Advantageously, as a result, said business entity's profitability improves dramatically, and its variability in earnings is reduced.

### SUMMARY OF INVENTION

This invention relates to a computer-implemented method for improving profitability of a business entity, comprising the steps of:
(A) selecting an income statement of a business entity for a specific period of time, having numerical values for at least the following measures: total revenue, costs of goods (or services) sold, gross profit, operating expenses and net operating income, all of which shall have meanings defined under Generally Accepted Accounting Principles (GAAP);
(B) decomposing said income statement into two or more (and often thousands) transaction-specific sub-components, each having the same minimum measures as the original income statement and, when summed, equaling the original income statement, where each sub-component represents a specific line item on a specific invoice during said period of time;
(C) associating said transaction-specific components with one or more hierarchical dimensions, wherein said all hierarchical dimensions have more than one node of hierarchy, and then aggregating transactions along said hierarchies, to produce a hierarchical series of specialized income statements of said at least one accountable unit and/or profitability measure for said more than one node along said all hierarchical dimensions, wherein the sum of said hierarchical series of specialized income statement of said at least one accountable unit and/or profitability measure along said all hierarchical dimensions is equal to said numerical value of said accountable unit and/or profitability measure in said overall income statement;
(D) identifying at least one node of said all hierarchical dimensions for subsequent structural change;
(E) making structural change to said at least one node of said all hierarchical dimensions identified in step (D), wherein said computer implemented method predicts an improvement in the profit or decrease in loss for said node of said all hierarchical dimensions identified in step (D);
(F) comparing the prediction in step (E) to actual improvement in the profit or decrease in the loss for said at least one node of said all hierarchical dimensions identified in step (D); and
(G) optionally, applying information from step (F) and repeating steps (A) through (G), periodically.

This invention also relates to the computer-implemented method recited above, wherein said decomposing step comprises:
(A2) decomposing the expense measures on the income statement into one or more aggregate measures for said specific period of time;
(B2) calculating an implied allocation rate for said expenses aggregate, according to an allocation method;
(C2) generating fully-loaded transactional data by distributing said expense aggregates to all said transaction-specific components along from said implied allocation rate calculated in step (B2);

and wherein, said aggregating step comprises:
(D2) generating a financial cube that enables said fully-loaded transactional data to be aggregated along hierarchical dimensions and at any level of hierarchy, such that:

$${\sum }_{i = 1}^{d 1} D 1 = {\sum }_{i = 1}^{d 2} D 2 = {\sum }_{i = 1}^{d 3} D 3 {\sum }_{i = 1}^{d 4} D 4$$

=sum of said specialized income statement of said at least one accountable unit and/or profitability measure;
wherein D1, D2, D3, and D4 represent sum of income relating to said hierarchical dimensions, said hierarchical dimensions having more than one level of hierarchy, wherein d1, d2, d3, and d4 correspond to the total number of items at a specific hierarchical level in said hierarchical dimensions.

### BRIEF DESCRIPTION OF DRAWINGS

FIG. 1/A and 1/B describe one embodiment of the profitability model and the sub-processes in the overall process.

FIG. 2 displays an example of a variance reduction over time as a result of the management review process.

### DETAILED DESCRIPTION OF INVENTION

### I. DEFINITIONS

In this patent application, ranges are used as shorthand only to avoid listing and describing each and every value within the range. Any appropriate value within the range can be selected as the upper value, the lower value, or the end-point of the range.

In this patent application, the singular form of a word includes its plural, and vice versa, unless the context clearly dictates otherwise. Thus, references “a,” “an,” and “the” generally include the plurals of the respective terms they qualify. For example, reference to “a method” includes its plural—“methods.” Similarly, the terms “comprise,” “comprises,” and “comprising,” whether used as a transitional phrase in the claims or otherwise, should be interpreted inclusively rather than exclusively. Likewise the terms “include,” “including,” and “or” should be construed to be inclusive, unless such a construction is clearly prohibited from the context. Similarly, the term “examples,” particularly when followed by a listing of terms, is merely exemplary and illustrative and should not be deemed to be exclusive or comprehensive.

The methods, compositions, and other advances disclosed in this patent application are not limited to particular methodology, protocols, and reagents described in the application because, as the skilled artisan will appreciate, they may vary. Further, the terminology used in this application describes particular embodiments only, and should not be construed as limiting the scope of what is disclosed or claimed.

Unless defined otherwise, all technical and scientific terms, terms of art, and acronyms used in the present application have the meanings commonly understood by one of ordinary skill in the art in the field(s) of the invention, or in the field(s) where the term is used. Although any compositions, methods, articles of manufacture, or other means or materials similar or equivalent to those described in the present patent application can be used in the practice of the present invention, specific compositions, methods, articles of manufacture, or other means or materials are described only for exemplification.

All patents, patent applications, publications, technical and/or scholarly articles, and other references cited or referred to in this patent application are incorporated in their entirety by reference to the extent allowed by law. The discussion of those references is intended merely to summarize the assertions made in these references. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

By “decomposition” is meant a breakdown of all business invoices by line items and a subsequent allocation of the quantities in each such line item to nodes along a hierarchical business dimension. “Dimensions” and “business dimensions” are described infra.

By “income statement” is meant the financial information from the business entity that includes revenue aggregates, expense aggregates and profitability measure, as defined by GAAP.

By ‘revenue aggregate’ is meant the sum of sales transactions, less any discounts, rebates, return or other contra sales charges.

By “expense aggregates” is meant expenses of the business entity that can be categorized within a specific type of business function. Illustrations of “expense aggregates” include engineering expense aggregate, marketing expense aggregate, sales expense aggregate, distribution expense aggregate, and administration expense aggregate.

By “profitability measure” is meant the gross profit, the net operating profit and/or the net profit, as commonly defined by GAAP. It should be noted that revenue aggregates and expense aggregates listed supra are simply for illustration purposes. The list is not exhaustive but rather depends on the type of business and its business need to discern the impact of a particular activity in its overall operation and how that activity relates to a particular quantifiable financial number of the business entity.

By a “business dimension” or a “dimension” or “hierarchical dimension” is meant an aspect of business that is defined by similarity of function, product, or geography. Illustrations of business dimensions include financial account, customer account, sales organization, distribution networks, and product.

By “root node” is meant the closest node to the business entity for a given business dimension. Similarly, by “leaf node” is meant the node closest to the sales transaction along any dimension. The leaf node is closest to the field and farthest from the business entity.

By “transaction-specific component” is meant the denormalized invoice line-item associated with nodes of each hierarchical dimension. A “transaction-specific component” is also called a “fully-loaded component” after the expenses have been associated with it as a result of the modeling process. Generally speaking, the “fully loaded component” is an intermediate product, whereas the aggregated financial cube, discussed infra, is the finished product.

By “accountable unit” is meant any subdivision of said business entity for which a profitability measure is calculated, projected and evaluated, and for which an employee of said entity is assigned responsibility for said measure. Such accountable unit relates directly to nodes in one of the multiple hierarchical dimensions discussed supra.

By “denormalization” is meant the division of an invoice of the business entity by each line item on the invoice. For example, if an invoice relates to five different items sold, the total invoice is divided along the five items with adequate weighting given to each item, which in a typical invoice would simply be the sale price of each item.

### II. GENERAL DESCRIPTION

In one aspect, the process of the present invention comprises three steps: (A) the profitability modeling step; (B) the strategic alignment step; and (C) the management operating system step.

The first step, that is, the profitability modeling step, is computer-implemented, which decomposes the business entity's income statement for a given period, for example one year, into a multi-dimension cube, allowing profitability to be evaluated by various parameters, such as customer, product, territory, distribution point, sales channel, and more. The model enables the business owner to identify the profit- and loss-making components of the business with improved accuracy.

The second step, that is, the strategic alignment step, represents a series of fundamental, one-time changes undertaken by the business entity based on the insights provided by the first step. Key alignment factors include pricing and discounts, product offerings, customer segments, service models and distribution networks

The third step, that is, the management operating system step, is an on-going management methodology based on periodic output from the profitability model. In this step, detailed financial plans are created with information derived from the first step. The plans are compared against actual results in periodic review meetings, and corrective action plans are prepared to remedy unfavorable variances.

A. Profitability Modeling Step

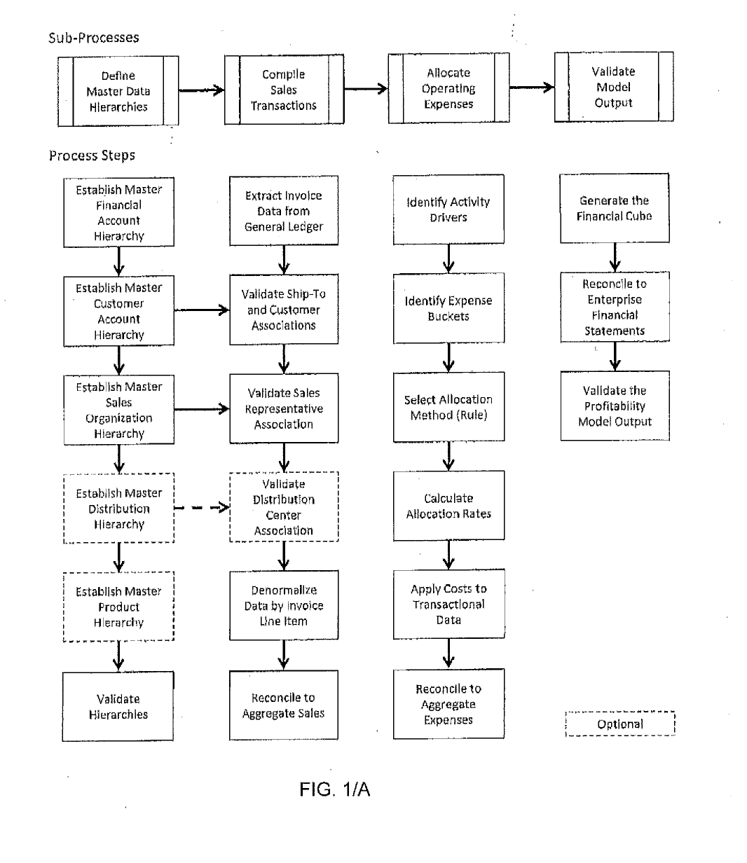

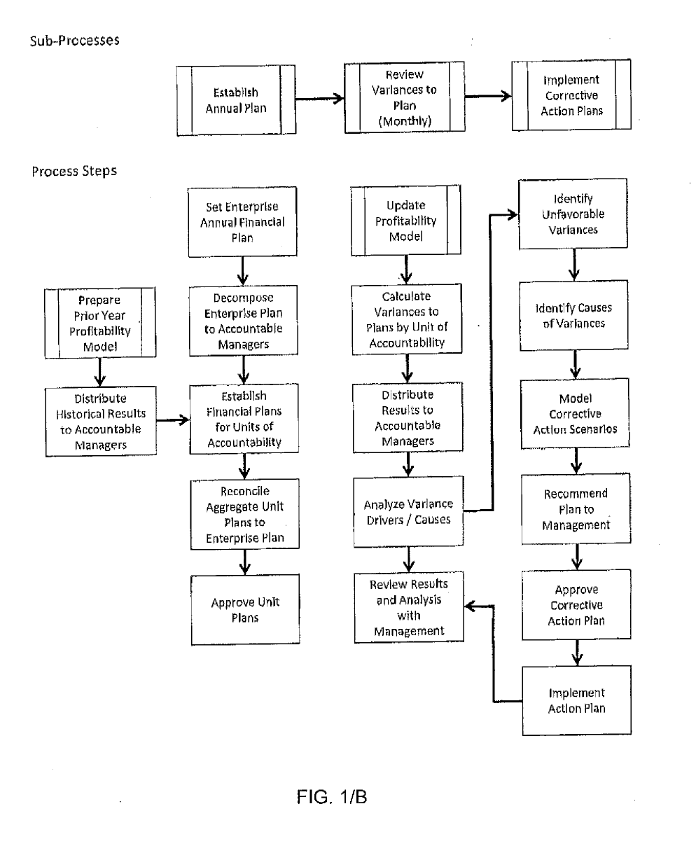

Generally speaking, the profitability modeling step decomposes the business entity's income statement into a series of transaction-specific components. A complete income statement is prepared for each line item on each invoice. As the most granular component of the entity's income statement, fully-loaded transactions can then be aggregated, for example, along multiple dimensions to produce specialized income statements by customer, product, distribution center, sales representatives, sales channel and more. The profitability modeling process comprises several sub-processes, as shown in FIG. 1 and described below.

1. Defining Master Business Data Hierarchies

As shown in FIG. 1, in the first sub-process of profitability modeling, in one embodiment, business data are collected and cleansed into standardized formats. Each data set along a dimension represents a hierarchical tree of data nodes; the original node is called the root node and the terminal node is called the leaf node, with intermediate nodes in between. Generally, the leaf node is linked to a sales transaction. In one embodiment, the data are be validated to ensure that the leaf nodes can be accurately tied to a valid root node in the hierarchical tree.

The master data hierarchical tree or hierarchy is established for at least one dimension during the modeling step. In a preferred embodiment of the invention, the master data hierarchy is established for more than one dimensions, such as product line, customer account, and sales organization.

As shown in FIG. 1, in one example, the business entity's income statement with leaf node account data is taken as input to the modeling process. In the next step, customer account structures—from the ultimate parent account entity to the individual ship-to sites are set up. Customer master data also include industry classifications and location data for each customer entity. Product master data are established in the next step that connect lines of business, to product lines, to products, and ultimately to individual stock keeping units (SKUs) as the leaf node. In the next step, the sales organization's hierarchy is established by connecting employees from the front-line sales representative through the senior executives of the entity. Similarly, the distribution network's master hierarchy is established by connecting the distribution points from the region, to the distribution center, to the delivery method or route. Preferably, business entity executives will validate data hierarchies as accurate.

2. Compiling Sales Transaction Data

In one aspect of the invention, as shown in FIG. 1, in the next sub-process, sales transaction data are compiled as the basis of the profitability model. Granular, discrete sales invoice data are compiled for subsequent costing in the allocation step, infra. Invoices for a baseline modeling period, for example, for twelve months, are extracted from the general ledger of the business entity's records. Each invoice is validated for a properly formatted date and amount. Each invoice is then associated with a leaf node for each modeled dimension, for example, the customer master data hierarchy, which is typically the ‘ship-to’ customer site. In a preferred embodiment, each invoice is also associated with a sales representative, thus linking the invoice to a leaf node on the organization hierarchy. In another preferred embodiment, each invoice is associated with a distribution center, thus linking the invoice to a leaf node in the hierarchy of the distribution network dimension. Once the associations between invoices and various nodes along a hierarchical dimension are established, the invoice data are denormalized into SKU-specific line items, where SKU means stock keeping unit. Stated another way, the quantities in the invoice are divided up by its line item as it they are associated with a particular node of the product or service hierarchical dimension. Each line item should include a quantity, discount rate, list price and net sale price, plus the customer, organization, and distribution node links described above. Clearly, the sum of the invoice amounts must be reconciled with the revenue data on the business entity's income statement for the same period.

3. Allocating Operating Expenses

In one aspect of the invention, as shown in FIG. 1, in the next sub-process, the profitability model allocates business entity's operating expenses to the invoice line items prepared in the preceding step. More specifically, the allocation sub-process applies all direct and indirect costs down to individual business transactions in manner that is reflective of the specific and accurate cost-to-serve associated with each business transaction. Directly correlated costs and revenues (e.g. from materials costs and price of individual products) are associated with the relevant transactions. Non-directly correlated costs (e.g. marketing, overhead) are allocated back to individual transactions so that the relevant costs and revenues are associated with transactional activity in a manner that accurately reflect complexity, costs, and effort are mapped and assigned to specific transactions.

Based on a detailed assessment of the business entity's operations, certain quantifiable activity drivers of business expense are identified. Activity drivers that best correlate to the business entity's expenses are selected. Preferred activity drivers include, but are not limited to, (a) the number of sales transactions processed; (b) the sum of revenue generated; (c) the quantity or volume of products sold; and (d) the percentage of an organizational department's time dedicated to a task or function.

Next, for each activity driver selected for the business entity, corresponding expense aggregates are identified. For overhead expenses without a clear activity driver, a blend of several drivers may be used as a proxy. The sum of the business entity's expenses must equal the sum of the cost aggregates used in the profitability model. All expense aggregates must be associated with an activity driver, or combination thereof. Examples of expense aggregates include engineering expense aggregate, marketing expense aggregate, sales expense aggregate, distribution expense aggregate, and administration expense aggregate.

In the next step, as shown in FIG. 1, allocation methods are selected. In preferred embodiments, allocation methods include single driver methods, blended methods, and multi-tiered methods. Other allocation methods with varying weightages, that is, blended transactions, are also included within the scope of the present invention.

In an embodiment, wherein the allocation method is the single driver method, expenses are spread based on the percentage of total sales revenue represented by a transaction. In yet another embodiment, expenses are spread based on the number of sales transactions. For example, implied allocation rate is calculated as follows:

$$\frac{\sum Expense}{\sum Activity} = \begin{matrix}Allocation \\ Rate\end{matrix}$$

In another preferred embodiment, blended allocation methods combine two single driver methods (supra) in parallel. For example, in the “Revenue/Transactions” method, weightage could be applied such that, for example, for administration expense, 50% of the expense is allocated based on sales revenue and 50% of the expense is allocated based on sales transactions. The allocation percentage can shift based on the fundamentals of the business entity and decision by the executives of the business entity. Similarly, in the “Volume/Transactions” method, especially in many commodity-oriented businesses, expenses are allocated 50% by the volume of product sold (such as quantity in barrels), and 50% by the number of transactions. Once again, the allocation percentage can shift based on the fundamentals of the business entity and decision by the executives of the business entity. In yet another embodiment of the blended allocation method, that is, the “blending rates” method, the percentage of expense weighted to the transactional component ranges from 50% to 70%, with higher percentages being allocated to businesses with more customized transactions. As a matter of illustration, custom product formulations, for instance, often have greater transactional expense compared to commodity products. The percentage of expenses weighted to the transactional component can also be 51%, 52%, 53%, 54%, 55%, 56%, 57%, 58%, 59%, 60%, 61%, 62%, 63%, 64%, 65%, 66%, 67%, 68%, 69%, and 70%. It can also assume intermediate numbers between any two numbers stated here, for example, 51.1%, 51.2%, 51.3%, 51.4%, 51.5%, 51.6%, 51.7%, 51.8%, 51.9%, and so on, and so forth. Stated another way, between every integer number listed herein, the weighted percentage expense can be a number that is 0.1% interval from a previous number, starting with the lower integer percentage number, as expressed for the two numbers 51% and 52% above.

In yet another preferred embodiment, said allocation methods include multi-tiered methods. Multi-tiered allocation methods use one or more single driver methods in sequence. For example, in the “Effort—Unit Volume” method, the engineering department is surveyed to determine the percentage of their time spent on individual products or product lines. This percentage of their operating budget (e.g. expense) is allocated to the product line or product. In a subsequent step, the pool of expense allocated to a product or product line is divided equally amongst the units of the product sold. The result is a custom allocation rate per product or product line. Similarly, in the “Spend—Sales Revenue” method, marketing expense is first allocated to specific geographic regions, typically based on advertising spend or marketing events. In a subsequent step, the pool of expense for each region is allocated by sales revenue. The result, therefore, is a custom allocation rate per region.

In the next step, using the rates calculated by one of the methods described above, costs in each expense aggregate are distributed to the transactional data. For each transaction specific-subcomponent:
All activity drivers required by the allocation rates are quantified and associated with the transaction;
The allocation rate for each expense aggregate is multiplied by the related activity driver;
The product represents the portion of the expense aggregate allocated to the transaction;
The allocated expense aggregates are subtracted from the transaction revenue to calculate the transaction specific profitability measure.

4. Validating the Model Output

In the first step towards validating the profitability model, the financial cube is generated. The financial cube enables the fully-loaded transactional data to be aggregated along any hierarchical dimension that is supported in the Master Business Data Hierarchies (See FIG. 1). By associating leaf node values from the hierarchy to each sales transaction line item, the transactional data can be aggregated at any level of the hierarchy, such as customer, product line, distribution zone or sales representative.

It should be noted that the following equation must hold true for the modeling process:

$${\sum }_{i = 1}^{c} C = {\sum }_{i = 1}^{p} P = {\sum }_{i = 1}^{s} S = {\sum }_{i = 1}^{d} D = \begin{matrix}Enterprise \\ Profit\end{matrix}$$

where:

C=customer profit;

c=total number of customers;

P=product profit;

p=total number of products;

S=sales representative profit;

s=total number of sales representatives;

D=distribution center profit; and

d=total number of distribution centers.

Allocations fully reconcile with business entity's income statement allowing for cube-based stacking and sampling of transactional data while maintaining integrity of reconciliation. The model aggregates must equal the business entity's income statement for total revenue, cost of sales, gross profit, operating expenses and net operating income. In all embodiments, regardless of which dimension of the financial cube is used to aggregate the model, these five aggregate measures remain equal to the enterprise income statement.

Sum cheeks are performed and positive and negative variances are dynamically reapplied to the transaction set to ensure full reconciliation between the transaction set and the financial statements. This step also identifies omissions or misclassifications that are then corrected.

The validity of the profitability model is driven by its acceptance by the business entity. The rules for allocating expenses are reviewed and in one embodiment, refined through successive iterations of the model inputs and cleansing of the underlying business data. Expense aggregate can be added in subsequent revisions, making the expense allocations more granular and the activity drivers more precise.

B. Strategic Alignment Step

The strategic alignment step includes specific profit maximization methodologies, including a highly analytical and structured approach for business operation, its continuity and for optimization of its asset portfolio. In one embodiment, this structured approach has distinct and repeatable steps, which leverage the detailed profitability modeling data from Step (A) to create analytical models to assess historical performance of the business entity; to develop scenarios to assess against distinct criteria (see infra under “Activity 2: Portfolio Attractiveness Criteria Review and Weighting”); and finally, to manage in the future, said entity's business portfolio and model.

An object of the present invention includes leveraging the transaction-based profitability modeling data to guide strategic commercial decisions, and to improve operating performance and overall business profitability.

Another object of the present invention is to understand the historical and projected future profitability, that includes determining, the historical performance of the portfolio, the key drivers of profitability, and whether the historical performance is expected to continue at the same level, improve, or deteriorate in the future given market volatility.

Yet another object of the present invention is to understand the value of different business models and strategic options, that includes determining the viability of the current business model for the portfolio, and corrective steps to be taken if not profitable, the options that are available to change the business model meaningfully, and the changes to be made to improve the portfolio's profitability to contribute to the overall return on capital employed (ROCE target the steps if the current business model is not viable.

In another objective, the present invention provides information sufficient to make decisions about the recommended future business models of the individual ports, including determining if the business will be more profitable if it stays in the portfolio under the current model, under a modified business model, or exiting the business completely; and if the portfolio's exits the business, the long-term commitments that are in place that will affect profitability or reduce the available alternatives.

The strategic alignment step includes the following three sub-steps.

Activity 1: Building Portfolio Performance and Scenario Models

In this activity, analytical evaluation and scenario models are built for each distinct business “portfolio.” A portfolio is defined as a business entity that operates with enough independence to be able to assess the level of net operating income and the ROCE performance from data from the profitability model and associated organization financial reports such as Income Statement and Balance Sheet.

The performance summary for the portfolio includes all the material income statements including revenues, costs, all levels of operating expense, and estimated taxes. In addition, the model includes material balance sheet information including average inventory, Net Payables and Plant, Property and Equipment.

The key performance and scenario evaluation metrics include: Volume, Net Unit Margin and ROCE.

The scenario model functionality built into each model allows for all key operating and financial elements to be changed such as Ship to's, Products, Volumes, Pricing (Spot or Term), commercial discount structure, cost of goods sold (COGS), and primary and secondary expense by multiple levels including units and transactions. The scenario model functionality allows the user to project key performance metrics for pro forma or projected periods, using the rates derived in the profitability modeling process.

As each assumption is changed in the scenario, the performance summary and the key operating and financial metrics are updated and evaluated.

Activity 2: Portfolio Attractiveness Criteria Review and Weighting

In this activity, an analytical model with distinct portfolio attractiveness criteria for weighting is developed for a portfolio. The criteria include both objective and subjective elements such as Capital Employed, Operating Income after Tax, Link to corporate system/assets and business model. Alignment with Business Strategic Imperatives, and Risk of Execution. The link to corporate system/assets refers to the consistency of fit between the other business units and the subject business unit. For example, an oil company would have a natural linkage to owning gas stations, whereas there would be less linkages to owning clothing stores. Each criteria is evaluated and ranked on a scale of 1 to 5, where 1 is the least attractive ranking for each portfolio attractiveness criteria and 5 is the most attractive ranking for each portfolio attractiveness criteria. The criteria include clear guidance to assist the objective and subjective scoring methodology:

1. Capital Employed: Portfolios are force-ranked into quintiles (5ths) based upon the pro-forma capital employed.

2. Profit After Tax (PAT): Portfolios are force-ranked into quintiles (5ths) based upon the pro-forma PAT.

3. Link to Corporate System and Business Model: Portfolios are scored in quintiles relative to their linkage to the overall system (e.g. equity position).

4. Alignment with Business Strategic Imperatives: Portfolios are scored in quintiles to the degree they align with strategic imperatives.

5. Risk if Execution: Portfolios are scored in quintiles as to their risk of obtaining their forecasted performance with the assumption that forecasted performance similar to the historic performance generally has lower risk of execution.

The methodology evaluates and ranks each criterion for the given portfolio. These ranking is weighted by the relative importance of each criterion based on a thorough rough evaluation. Stated another way, the first estimate/outcome is desired to be as good as possible, but there will be successive refinement. The weighting for all the criteria, that is addition of all the criteria for a given portfolio, adds up to 100%. The individual item score of the five criteria would be the ranking score (1-5) multiplied by the weighting (%) and the summary of all the items score for a respective portfolio would be total score for the portfolio. The total score would be used as the analytical approach to rank the level of all the portfolios on a scale of most to least attractive. The total scores can also be used to set thresholds which help management decision making on attractiveness and viability, which may support some strategic rationalization and divestiture from the business model. In one embodiment, the formula to calculate the total score example is as follows:

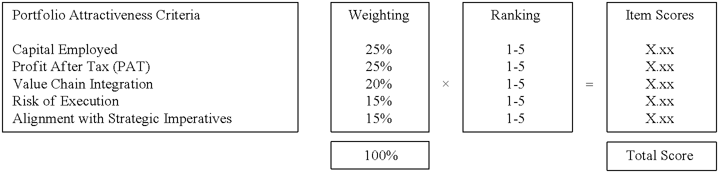

This methodology is used with both historical performances to set the baseline and to assess future performance based on specific and direct improvement scenarios which are developed in the Pro-Forma Portfolio Performance and Scenario Models.

Activity 3: Develop Portfolio Pro-Forma Results

In this activity, the Portfolio Performance and Scenario Models are used to develop future scenarios of financial performance based on evaluation and modeling of various business and financial assumptions and sensitivities. The key performance metrics which include: Volume, Net Unit Margin and ROCE are recalculated based on changes in all material operating, commercial, and financial elements built into the model such as Ship to's, Products, Volumes, Pricing (Spot or Term), commercial discount structure, COGS, primary and secondary expense by multiple levels including units and transactions. By “Ship-to's” is meant points of delivery. The term is used in conjunction with Sold-To's. For example, if a corporation owns five gas stations, the corporation may be the ‘Sold To’ as they're paying all the bills, and each gas station would be a ‘Ship To’, meaning they each take delivery of the purchased product.

In the next step, the business entity conducts working sessions to brainstorm and run new scenario and sensitivity assumptions to assess potential future performance so that the models and Pro-Forma results process have distinct inputs, scenarios, and outputs. Stated another way, in one embodiment, Based on the working sessions with the business leaders, different options (scenarios) are developed—each with its own set of input assumptions, Given the different inputs, different outputs (Key Indicators) are produced for consideration.

The Inputs include the following: Historical Financials for three years or more and historical details including: revenues (volumes and margins), product costs, and secondary costs, overhead expenses, working capital and other historical commercial arrangement.

The Scenarios include the following: projected and modeled financials for at least three future years compared with historical performance and potential scenario analysis financial changes such as supply chain/logistics strategies, lease versus own asset strategies, and many commercial and operational changes such as product mix, volumes, and all cost and expense alternatives.

The Outputs include the following: quantified financial outcomes for scenarios (individual and multi-variable) and net present value calculations for exit scenarios. The output also includes important strategic and tactical recommendations including; business mode, exit/improve/restructure, and strategic choice-specific.

In addition, a detailed and structured action plan is developed to include all the key elements and timelines required to achieve the chosen Pro-Forma scenario financial performance. Stated another way, once a scenario is selected to pursue/implement, an action plan is required to make it happen. The elements of the action plan include, short term actions and due date, long term actions and due date, competitor considerations such as who the competitors are, their activity, and their reaction to the change; customer considerations such as contractual obligations, the business entity's options, and whether the change is a strategic issue for customers. The action plan also includes whether the change fits within the strategic imperatives of the business, and risks associated with the business as a result of the change, and the mitigating strategies for all potential risks. The action plan further includes key contract-related decision points in the short term.

The action plans will dictate and guide all tactical commercial activity and priorities and be used as a roadmap to track progress towards achieving the targeted scenario financial performance. The ongoing financial performance will be fully monitored at all material levels in the Management Operating System step (C).

C. Management Operating System Step

The final step of the present invention distributes accountability for profitability optimization to all levels of the business organization through a recurring series of reports, plans and reviews, collectively called the Management Operating System.

The Management Operating System requires at a minimum of four primary elements: (1) Formulate detailed financial plans for each accountable unit; (2) Calculate variances at all levels of reported units; (3) Disseminate results allowing for executive leadership, mid-tier management, and front-line operators to view identical net income, plan and variance data for the entire, or their particular segment of the organization; and (4) management review and corrective action processes to address unfavorable variances.

1. Detail Financial Plans

In a preferred embodiment the profitability model associates each transaction with a leaf node at any level of the hierarchy, such as customer, product line, distribution zone or sales representative. Aggregates of these hierarchies must be determined to identify business units that are related to individual areas of accountability within the organization. This additional layer of accountability means that there is one additional hierarchy, the Business Unit, that must be objectified to complete the requirements for a Management Operating System.

It should be noted that the following equation must therefore hold true for the planning process:

$${\sum }_{i = 1}^{c} {C}^{Plan} = {\sum }_{i = 1}^{p} {P}^{Plan} = {\sum }_{i = 1}^{s} {S}^{Plan} = {\sum }_{i = 1}^{d} {D}^{Plan} = {\sum }_{i = 1}^{b} {B}^{Plan} = \begin{matrix}Enterprise \\ Planned Profit\end{matrix}$$

where:

C^{Plan}=customer planned profit;

c=total number of customers;

p^{Plan}=product planned profit;

p=total number of products;

S^{Plan}=sales representative planned profit;

s=total number of sales representatives;

D^{Plan}=distribution center planned profit; and

d=total number of distribution centers.

B^{Plan}=business unit planned profit; and

b=total number of business units.

The financial plans for each Accountable Unit are based on a detailed Pro-Forma model of the Units profitability, including the following customer-specific assumptions:

a. Projected Sales Volumes
The Accountable Manager will forecast the unit sales volume for each Unit. In case where the volume sold is governed by a term purchase contract with a customer or distributor, the Accountable Manager may specify maximum or minimum limits by product and/or point of shipment.

b. Pricing and Discount Assumptions
Accountable Managers should specify maximum discount rates to be granted to ensure the profitability of the Unit.
For example, in cases of commodity markets where prices are set at periodic intervals based on publicly available market prices, the Pro-forma can include a price protection factor to account for the unfavorable cost variances during fixed price period. The price protection factor can be calculated by calculating the average price increase from the beginning of a pricing period to its end date. For example, if prices are fixed every Monday, the price protection factor would be the average price increase from each Monday during the preceding contract term to the following Sunday.

c. Terminal/Distribution Rates
The Manager shall forecast volume by shipment point, such as a distribution center, warehouse or terminal. Shipments from that terminal shall be burdened by location-specific costs based on rates derived from the Profitability Model.

d. Customer-Specific Rates
The Manager shall forecast volume by customer site, also known as ship-to location. Costs for transportation and order processing shall be applied based on customer-specific rates derived from the Profitability Model.

2. Calculated Variances

The profitability model is updated with actual financial results and distributed to Accountable

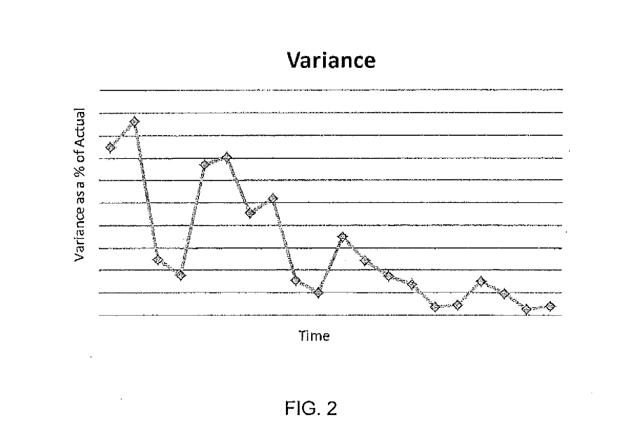

Managers on a monthly basis. Actual results are compared to the financial plan for each unit of accountability. FIG. 2 displays a sample of what a variance reduction might look like over time as a result of this management review process. Realizing that there may be some, more random influences on performance such as weather, calendar timing and other business cycles, to name a few, the objective of this process is to reduce the variance as a percentage of actual results for each consecutive reporting period.

For example, if the summation of planned Sales Revenue was 100 and the summation of actual reported results were 120 the absolute variance to actuals would be calculated as 20% per the calculation below.

$$\frac{Absolute ( {\sum }_{i = 1}^{r} {Revenue}^{Actual} - {\sum }_{i = 1}^{r} {Revene}^{Plan} )}{{\sum }_{i = 1}^{r} {Revenue}^{Actual}} = \begin{matrix}Revenue \\ Variance\end{matrix}$$

3. Dissemination of Results

The combined results of actual profitability, planned profitability and variance will be delivered to executive leadership, mid-tier management, and front-line operators through a presentation layer manifestation referred to as the management operating system. The management operating system presentation layer will include at a minimum a front page with a menu of available page views. The first of these page views includes a global consolidated income statement with clearly defined revenue, cost of goods sold, direct operating expense, indirect operating expense and total net income for the entire business entity. Each of these aggregate accounts may be expanded to more detailed chart of accounts. There will be columns showing actual results, planned results and the variance calculation, or difference between actual and planned results.

The results provided in the presentation layer will consistent throughout the management operating system meaning that:

$${\sum }_{i = 1}^{c} C = {\sum }_{i = 1}^{p} P = {\sum }_{i = 1}^{s} S = {\sum }_{i = 1}^{d} D = {\sum }_{i = 1}^{b} B = \begin{matrix}Enterprise \\ Profit\end{matrix}$$

$${\sum }_{i = 1}^{c} {C}^{Plan} = {\sum }_{i = 1}^{p} {P}^{Plan} = {\sum }_{i = 1}^{s} {S}^{Plan} = {\sum }_{i = 1}^{d} {D}^{Plan} = {\sum }_{i = 1}^{b} {B}^{Plan} = \begin{matrix}Enterprise \\ Planned Prof ••\end{matrix}$$

$${\sum }_{i = 1}^{c} {C}^{Variance} = {\sum }_{i = 1}^{p} {P}^{Variance} = {\sum }_{i = 1}^{s} {S}^{Variance} = {\sum }_{i = 1}^{d} {D}^{Variance} = {\sum }_{i = 1}^{b} {B}^{Variance} = \begin{matrix}Enterprise \\ Variance\end{matrix}$$

Anyone accessing the management operating system will therefore gain a complete view of profit, planned profit, and variance of actual to planned profit for all levels of the hierarchy throughout the organization. The only limitation to this capability may be provided with additional layers of security providing for segments of the above hierarchies to be viewed by authorized executives, mid-tier managers or front line operators.

4. Management Review Cycle

Accountable managers at each level of the organization review actual results and corresponding variances to plan. These management review cycles should be conducted, at a minimum, on a quarterly basis. The process involves review of actual to planned results at a minimum over three levels of the organization. Level 1 defined as executive management that would include the Chief Executive Officer, Chief Financial Officer or the President of larger more multinational organizations. Level 2 defined as Vice Presidents, or division leaders reporting to Level 1 officers. Level 3 defined as front line operators who typically have direct control over the business decisions, employees and resources that have a more immediate impact on favorable and unfavorable income statement performance. Defined this way every part of the organization has a person who should be named as responsible for the entire organization, a particular branch and therefore subgroup of the organization, or a specific leaf node in the organizational tree.

The effectiveness of this review process is enhanced by the hierarchical nature of the MOS reporting structure such that Level 1 management can see the cumulative Actual, Plan, and Variance results for the entire organization. Security protocols then permit Level 2 management to see their particular segment or subdivision of the organization. Similarly Level 3 (and any lower levels) would only be permitted by the same security protocols to review their subset of the organization.

The review process would therefore permit managers at all levels to isolate more salient causes of variance, target responsibility ask for remediation plans from the responsible Level 1, Level 2 or Level 3 person.

Accountable managers are required to create corrective action plans to remedy unfavorable variances. Tactics include discount adjustments, fee assessments, service level adjustments and product substitutions.

### III. EXAMPLES

1. Examples of Master Data Hierarchies

In Table 1, a sample of hierarchical dimensions is shown. The following dimensions are shown by way of examples.

A. Enterprise Financial Hierarchical Dimension

The financial dimension hierarchy is used to create ‘Expense Aggregates’ according to the process description supra. In the example, the second level—selling expense—is used as the expense aggregate.

B. Customer Hierarchical Dimension

In this hierarchical dimension, the ‘ship-to’ location—the customer site to which the physical delivery is made—is the leaf node. The sites roll up to an ultimate parent; in this example, it is a global corporation.

C. Product Hierarchical Dimension

The SKU, or stock keeping unit, is the lowest level of the product hierarchy, that is, the leaf node, and rolls up to a ‘line of business’ or ‘business unit.’

D. Sales Organization Hierarchical Dimension

The leaf node of the sales organization is an individual sales representative. The hierarchy rolls up through the highest levels of the sales organization, which are often regions or divisions.

E. Distribution Network Hierarchical Dimension

The lowest level of the distribution hierarchy, that is, the leaf node, is often a distribution center, or ideally an individual route or delivery driver. The hierarchy often rolls up to a ‘distributive area,’ which is tied to a specific manufacturing plant.

TABLE 1
Dimensional Hierarchies

| | | | | | Distribution |
|---|---|---|---|---|---|
| SAMPLE DATA HI- | Financial Hierarchical | Customer Hierarchical | Product Hierarchical | Sales Organization | Network Hierarchical |
| ERARCHIES | Dimension | Dimension | Dimension | Hierarchical Dimension | Dimension |
| Root Node | Operating Expenses | Acme Global, Inc. | Surgical Products | US East | Eastern Distributive |
| | | | | | Area |
| Hierarchical (or | Sales Expenses | Acme North America | Sutures | Mid-Atlantic Region | Great Lakes Zone |
| | | Inc. | | | |
| Intermediate Node) | Travel & Entertainment | Acme Logistics | Polled Synthetic - white | District 3 | Toledo Distribution |
| | Expenses | | | | Center |
| Leaf Node | Air Travel | Acme Store No. 233 | SKU884F5 | State Rep. No. 23, Mr. | Route No. 5A |
| | | | | Tierney | |

2. Examples of Sales Transaction Data Imported from General Ledger Systems

As shown in Table 2, sales transaction data (columns A-G) are exported from the corporate general ledger systems. An invoice typically includes more than one product, so the data must be ‘denormalized’ to produce one product (stock keeping unit, or ‘SKU’) per row. Ship-to-customer site, sales person, and discount rate are all derived from the invoice, so are thus repeated across the rows. Similarly, marketing regions, delivery route and other hierarchies may or may not be directly embedded within the invoice data, but is easily associated during the data-cleansing phase (see columns H-K).

3. Examples of Expense Aggregates and Allocation Rate Calculations

As shown in Table 3, the income statement (columns A-C) is used to provide is an input to the modeling. The income statement comprises of revenue measures, expense aggregates and profitability measures. Specifically, the operating expenses are aggregated along key functional areas, such as engineering, distribution, sales, etc. (expense aggregates). Based on an analysis of the business fundamentals, key activity drivers are identified for each expense aggregate, as shown in column A. The expense aggregates as well as the activity drivers are used for allocating expenses. Allocation methods can be categorized as single driver methods, blended methods and multi-tiered methods.

A. Single Driver Methods

Examples of single driver methods are as follows:

(1) Sales Revenue Method

As discussed supra, the simplest allocation method is spreading expense based on the percentage of total sales revenue represented by a transaction. In the example, the selling expense is $2,399,000 and the revenue is $18,200,240. Thus, $0.13 of selling expense is allocated to every $1 in revenue ($2,399,000/$18,200,240=0.13).

(ii) Sales Transactions Method

In another single driver method, expense is spread based on the number of sales transactions. In the example, the distribution expense is $2,898,000 for 5,318 total transactions. Thus, $544.94 of distribution expense is allocated to every sales transaction, or fraction thereof ($2,898,000/5,318=$544.94).

B. Blended Methods

As discussed previously, blended methods involve combining two single driver methods in parallel. Some examples of blended methods for allocation rate calculation are as follows:

(i) Revenue/Transactions Method

In the example of administration expense, 50% of the expense is allocated based on sales revenue, that is $0.04 per $1 of sales revenue, and 50% of the expense is allocated based on sales transactions, that is, $136.33 per transaction.

(ii) Volume/Transactions Method

In many commodity-oriented businesses, expenses are allocated 50% by the volume of product sold, such as quantity in barrels, and 50% by the number of transactions.

(iii) Blending Rates Method

In this method, the percentage of expense weighted to the transactional component ranges from 50% to 70%, with higher percentages being allocated to businesses with more customized transactions, for example, custom product formulations often have greater transactional expense compared to commodity products.

C. Multi-Tiered Methods

Multi-tiered allocation methods use one or more single driver methods in sequence.

(i) Effort—Unit Volume Method

In this example, the engineering department is surveyed to determine the percentage of their time spent on individual products or product lines (see column N). This percentage of their operating budget (e.g. expense) is allocated to the product line or product. In a subsequent step, the pool of expense allocated to a product or product line is divided equally amongst the units of the product sold (column L). The result is a custom allocation rate per product or product line (column P).

(ii) Spend—Sales Revenue Method

In this example, marketing expense is first allocated to specific geographic regions, typically based on advertising spend or marketing events (see column N). In a subsequent step, the pool of expense for each region is allocated by sales revenue (column L). The result is a custom allocation rate per region (column P).

D. Expense Allocation

Operating expenses are applied to individual transactions based on the allocation rates in prior steps (columns P-T). Following the allocation of operating expenses, a transaction specific Net Operating Income measure can be calculated (column V).

E. Financial Cube Aggregation

With a specific NOI measure calculated for each transaction, the NOI values can be summed along any dimension of the associated hierarchies.

What is claimed is:

1. A computer-implemented method for improving profitability of a business entity, comprising the steps of:
(A) selecting an income statement of a business entity for a specific period of time, having numerical values for at least the following measures: total revenue, costs of goods (or services) sold, gross profit, operating expenses and net operating income, all of which shall have meanings defined under Generally Accepted Accounting Principles (GAAP);
(B) decomposing said income statement into two or more (and often thousands) transaction-specific sub-components, each having the same minimum measures as the original income statement and, when summed, equaling the original income statement, where each sub-component represents a specific line item on a specific invoice during said period of time;
(C) associating said transaction-specific components with one or more hierarchical dimensions, wherein said all hierarchical dimensions have more than one node of hierarchy, and then aggregating transactions along said hierarchies, to produce a hierarchical series of specialized income statements of said at least one accountable unit and/or profitability measure for said more than one node along said all hierarchical dimensions, wherein the sum of said hierarchical series of specialized income statement of said at least one accountable unit and/or profitability measure along said all hierarchical dimensions is equal to said numerical value of said accountable unit and/or profitability measure in said overall income statement;
(D) identifying at least one node of said all hierarchical dimensions for subsequent structural change;
(E) making structural change to said at least one node of said all hierarchical dimensions identified in step (D), wherein said computer implemented method predicts an improvement in the profit or decrease in loss for said node of said all hierarchical dimensions identified in step (D);
(F) comparing the prediction in step (E) to actual improvement in the profit or decrease in the loss for said at least one node of said all hierarchical dimensions identified in step (D); and
(G) optionally, applying information from step (F) and repeating steps (A) through (G), periodically.

2. The computer-implemented method recited in claim 1, wherein said decomposing step comprises:
(A2) decomposing the expense measures on the income statement into one or more aggregate measures for said specific period of time;
(B2) calculating an implied allocation rate for said expenses aggregate, according to an allocation method;
(C2) generating fully-loaded transactional data by distributing said expense aggregates to all said transaction-specific components along from said implied allocation rate calculated in step (B2);
and wherein, said aggregating step comprises:
(D2) generating a financial cube that enables said fully-loaded transactional data to be aggregated along hierarchical dimensions and at any level of hierarchy, such that:
$${\sum }_{i = 1}^{d 1} D 1 = {\sum }_{i = 1}^{d 2} D 2 = {\sum }_{i = 1}^{d 3} D 3 {\sum }_{i = 1}^{d 4} D 4$$
=sum of said specialized income statement of said at least one accountable unit and/or profitability measure;
wherein D1, D2, D3, and D4 represent sum of income relating to said hierarchical dimensions, said hierarchical dimensions having more than one level of hierarchy, wherein d1, d2, d3, and d4 correspond to the total number of items at a specific hierarchical level in said hierarchical dimensions.

3. The computer-implemented method as recited in claim 2, wherein said implied allocation rate is determined by dividing the sum of at least one expense aggregate by said numerical value of at least one activity driver.

4. The computer-implemented method as recited in claim 2, wherein said implied allocation rate is determined by the blending method or the multi-tier method.

5. The computer-implemented method as recited in claim 1, wherein an activity driver is selected from the group consisting of (a) the number of sales transactions processed; (b) the sum of revenue generated; (c) the quantity or volume of products sold; and (d) the percentage of an organizational department's time dedicated to a task or function.

6. The computer-implemented method as recited in claim 1, wherein said all hierarchical dimensions comprise enterprise financial data, customer data, product data, sales organization data, and distribution network data.

7. The computer-implemented method as recited in claim 1, wherein said structural change is implemented in the leaf node of said all hierarchical dimensions.

8. The computer-implemented method as recited in claim 5, wherein said at least one profitability measure is net operating income.

9. The computer-implemented method as recited in claim 1, wherein said structural change is implemented in the root node of said all hierarchical dimensions.

10. The computer-implemented method as recited in claim 1, wherein said structural change is implemented in an intermediate node that is in between said leaf node and said root node of said all hierarchical dimensions.
